(19) United States
(12) Patent Application Publication
(10) Pub. No.: US 2008/0005887 A1
(43) Pub. Date: Jan. 10, 2008

(54) Elongated member/radially expandable member assembly and methods of assembling the same

(75) Inventors: Douglas W. Glenn, Des Moines, WA (US); Matthew T. Kokaly, Seattle, WA (US); Dean C. Madden, Coppell, TX (US)

Correspondence Address: SEED INTELLECTUAL PROPERTY LAW GROUP PLLC, 701 FIFTH AVE, SUITE 5400, SEATTLE, WA, 98104, US

(73) Assignee: Fatigue Technology, Inc., Seattle, WA (US)

(21) Appl. No.: 11/807,193

(22) Filed: May 25, 2007

Related U.S. Application Data
(60) Provisional application No. 60/808,600, filed on May 26, 2006.

(51) Int. Cl. B23P 9/00

(52) U.S. Cl. 29/523; 29/525

(57) ABSTRACT

At least one embodiment generally relates to using an installation tool to pass an expansion mandrel through an elongated member to at least locally, radially expand at least a portion of the elongated member and achieve an interference fit with a radially expandable member located about an outer surface of the elongated member. In one embodiment, the elongated member is radially expanded over its entire length and may include a stepped feature so that only a portion of the elongated member achieves the interference fit with the radially expandable member. During the radial-expansion process, both the radially expandable member and the elongated member may be at the same or approximately the same temperature. Before the radial-expansion process, the radially expandable member may be assembled using press-fit techniques, shrink fit techniques, clearance fitting techniques, or combinations thereof.

### CROSS-REFERENCE TO RELATED APPLICATION

This application claims the benefit under 35 U.S.C. § 119(e) of U.S. Provisional Patent Application No. 60/808,600, filed May 26, 2006, where this provisional application is incorporated herein by reference in its entirety.

### BACKGROUND OF THE INVENTION

1. Field of the Invention

This disclosure generally relates to methods of installing radially expandable members onto hollow, elongated members such as elongated members, axles, and/or shafts.

2. Description of the Related Art

One conventional process for installing radially expandable members on elongated members such as elongated members, axles, and/or shafts is a thermal technique where the radially expandable member, the elongated member, or both are respectively heated and/or cooled. When cooling is used, the process is generally referred to as a shrink or a freeze fit process. In one example, the receiving part would be the radially expandable member and the cooled, insertable part would be the elongated member. Thus, the elongated member is cooled in a cryogenic fluid to reduce at least the outer diameter and then rapidly placed into the room temperature radially expandable member. Because of the large temperature difference between the elongated member and radially expandable member, the elongated member is typically received into the radially expandable member with at least a slight clearance fit. One drawback of the shrink fit assembly technique is that the elongated member must be placed in the radially expandable member, or vice-versa, quite rapidly because the dimensions of the elongated member will immediately and rapidly begin to increase once the elongated member is removed from the cryogenic fluid. The limited time available for an installer to assemble the components means that it is often difficult for the installer to properly and/or accurately index and/or orient the elongated member relative to the radially expandable member, if and when such indexation or orientation is necessary.

Another conventional process used to assemble a radially expandable member to an elongated member is the process of press fitting. Press fitting requires that the outer perimeter of the elongated member be slightly larger than the inner perimeter of the radially expandable member prior to the two components being forced together. During assembly, a component is forced on or into a stationary component. In press fitting processes, the tolerances between the radially expandable member and elongated member must be held very close; otherwise, the components may interfere too much and may not fit together or, in contrast, interfere too little, resulting in a less than satisfactory union between the components. In addition, press fitting is typically limited to use on smaller assemblies; otherwise, the pressing forces exceed the capabilities of even large mechanical presses. The press fitting process may be limited by the types of materials forming the components being assembled, may require large capital costs for specialized tooling to assemble uniquely shaped parts by applying large, controlled forces, and/or may cause unwanted damage to the components, in particular the surfaces that are in sliding, frictional contact during the press fit operation. These drawbacks, and others, may lead to manufacturing difficulties, increased manufacturing costs, in-service problems, and/or degraded operational performance of the components that were shrunk and/or press fit together.

Another assembling process is the FORCEMATE® installation method developed by Fatigue Technology, Inc. This process radially expands (cold works) one or more components, such as one or more radially expandable members or similar components, into a structural workpiece. The process may provide numerous benefits over shrink and/or press fitting, such as possibly increasing the fatigue life of components that will undergo repetitive load cycles and/or may be susceptible to accumulating fatigue damage during service.

By way of example, the FORCEMATE® installation method utilizes an expansion mandrel coupled to an installation tool to pass (e.g., push or pull) the expansion mandrel through an initially clearance-fit radially expandable member. The radially expandable member is contemporaneously placed or is already located in the opening of the structural workpiece when the mandrel is moved. The expansion mandrel includes a tapered or expansion head portion that radially expands the radially expandable member into the opening and may obtain a controlled, but higher interference fit than would be achievable by either the shrink or press fit processes. The FORCEMATE® installation method, which may be generally referred to as a type of cold-working and/or radial expansion method, the associated tooling, and related methods such as the BUSHLOC®, FORCETEC®, and FLEXMATE® processes are described in U.S. Pat. Nos. 3,566,662; 3,892,121; 4,187,708; 4,423,619; 4,425,780; 4,471,643; 4,524,600; 4,557,033; 4,809,420; 4,885,829; 4,934,170; 5,083,363; 5,096,349; 5,405,228; 5,245,743; 5,103,548; 5,127,254; 5,305,627; 5,341,559; 5,380,136; 5,433,100; and in U.S. patent application Ser. Nos. 09/603,857; 10/726,809; 10/619,226; and 10/633,294.

Based on the foregoing, it is desirable to have a method of installing a first component onto an elongated member, such as an elongated member, axle, shaft, etc., using cold-working/radial-expansion techniques. Further, it is desirable that such a method overcome at least one of the drawbacks discussed above, yet achieve a tight interference fit between a least a portion of the elongated member and the first component.

### SUMMARY OF THE INVENTION

At least one embodiment generally relates to a method of installing a radially expandable member, liner, gear, sprocket, cam lobe, spline, or other similar component (which hereinafter is referred to generally as a radially expandable or extending member for the sake of brevity) onto a hollow, elongated member such as an elongated member, axle, rod, extension member, shaft, or other similar component (which hereinafter is referred to generally as an elongated member for the sake of brevity) using cold-working/radial-expansion techniques. In one embodiment, an installation tool is used to draw an elongated expansion mandrel through the elongated member and locally, radially expand at least a portion of the elongated member to create an interference fit with the radially expandable member, which is located on an outer surface of the elongated member. The elongated member itself may be radially expanded over its entire length, may have features that allow only a portion of the elongated member to be radially expanded, and/or an insertable/removable tool may be inserted into the elongated member and then radially expanded to in turn radially expand at least a portion of the elongated member to create the interference fit with the radially expandable member. Before the cold-working/radial-expansion assembly process, the radially expandable member and elongated member may be assembled using press fit techniques, shrink fit techniques, clearance fit techniques, combinations thereof, or other assembling techniques. For example, the radially expandable member may be placed onto the elongated member with a clearance fit before any radial expansion of the elongated member. During the cold-working/radial-expansion assembly process, both the radially expandable member and the elongated member may be at the same or approximately the same temperature.

In some embodiments, an expandable member is configured to be fixedly coupled to an elongated shaft. For example, the expandable member and elongated shaft can be coupled together via an expansion process. The elongated shaft can include, in some embodiments, a means for radially expanding the elongated shaft against the expandable member. The means for radially expanding can include, without limitation, self-expanding materials (e.g., shape memory material), a necked portion, a sleeve with a thickened wall portion, and the like.

In some embodiments, an assembly comprises an expanded member and an elongated shaft extended through an axial passage in the expandable member. In some embodiments, the elongated shaft protrudes from one or both sides of the expandable member. The elongated shaft can be, for example, a rod, bar, or other member suitable for transmitting loads, if needed or desired.

In one aspect, a load path assembly includes an elongated shaft having an outer surface and an inner surface forming a longitudinally extending passage; and a radially extending member having an outer surface and an inner surface forming an axial passage, wherein the elongated shaft is longitudinally received in the axial passage of the radially extending member such that the radially extending member radially extends from the elongated shaft and is fixed thereon via a radial expansion interference fit between at least a portion of the outer surface of the elongated shaft and at least a portion of the inner surface of the radially extending member.

In another aspect, an assembly includes a member having an outer surface and an inner surface forming an axially extending passage; and an elongated shaft having an outer surface and an inner surface forming a longitudinally extending passage, the longitudinally extending passage of the elongated shaft having a pre-assembled radial dimension that provides a clearance fit with the inner surface of the rotational member and a post-assembled radial dimension that provides a radially expanded interference fit between at least a portion of the outer surface of the elongated shaft and at least a portion of the inner surface of the rotational member.

In yet another aspect, a method of forming an assembly from an elongated shaft having an outer surface and an inner surface forming a longitudinal passage, and from a member having an outer surface and an inner surface forming an axial passage, the method includes positioning at least a portion of the elongated shaft in at least a portion of the axial passage of the member such that the member radially extends from the elongated shaft; passing at least a portion of a mandrel through the longitudinal passage of the elongated shaft; and radially expanding at least a portion of the elongated member to form a radial expansion interference fit between at least a portion of the outer surface of the elongated shaft and at least a portion of member.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements and have been solely selected for ease of recognition in the drawings.

FIG. 1A is a side elevational view of an assembly comprising an elongated member and a radially expandable member where the assembly is shown in a pre-assembled state, according to one illustrated embodiment.

FIG. 1B is a side elevational view of the assembly of FIG. 1 showing the elongated member and the radially expandable member in a post-assembled state, according to one illustrated embodiment.

FIG. 2A is side elevational view of an elongated member having a positioner.

FIG. 2B is a side elevational view of an expandable member mounted to the elongated member of FIG. 2A.

FIG. 3A is a cross-sectional view of the elongated member of FIG. 2A taken along line 3A-3A.

FIG. 3B is another cross-sectional view of the elongated member of FIG. 2A taken along line 3B-3B.

FIG. 4A is a side elevational view of the radially expandable member of FIG. 1A.

FIG. 4B is a cross-sectional view of the radially expandable member of FIG. 4A taken along line 4B-4B.

FIG. 5A is a side elevational view of a radially expandable member having a positioner, according to one illustrated embodiment.

FIG. 5B is a cross-sectional view of the radially expandable member of FIG. 5A taken along line 5B-5B.

FIG. 5C is a cross-sectional view of the radially expandable member of FIG. 5A taken along the line 5C-5C of FIG. 5B.

FIG. 5D is a longitudinal cross-sectional view of an assembly including the radially expandable member of FIG. 5A and an elongated member.

FIG. 6 is an exploded, isometric view of the assembly of FIG. 1A, a portion of an installation tool, and an expansion mandrel, according to one illustrated embodiment.

FIG. 7 is an isometric view of the assembly, the installation tool, and the mandrel of FIG. 6 with the mandrel coupled to the installation tool and ready to radially expand the elongated member, according to one illustrated embodiment.

FIG. 8 is a side elevational view of the assembly of FIG. 1A with the mandrel of FIG. 6 received into an opening of the elongated member.

FIG. 9 is a cross-sectional view of the assembly and the mandrel of FIG. 8 taken along line 9-9 of FIG. 8.

FIG. 10 is a cross-sectional view of the elongated member and the radially expandable member being radially expanded by the mandrel of FIG. 6, according to one illustrated embodiment.

FIG. 11 is a side elevational view of an assembly comprising an elongated member and a radially expandable member shown in a pre-assembled state, according to one illustrated embodiment.

FIG. 12 is a cross-sectional view of the assembly of FIG. 11 taken along line 12-12 of FIG. 11.

FIG. 13 is a side elevational view of an assembly comprising an elongated member and a radially expandable member shown in a pre-assembled state with a mandrel and an expansion sleeve received in an opening of the elongated member, according to one illustrated embodiment.

FIG. 14A is a cross-sectional view of the assembly of FIG. 13 taken along line 14A-14A of FIG. 13 showing the expansion sleeve having a stepped-up perimeter portion, according to one illustrated embodiment.

FIG. 14B is a side elevational view of an expansion split sleeve for use in an elongated member.

FIG. 14C is a cross-sectional view of the expansion split sleeve of FIG. 14A in an unexpanded position taken along line 14C-14C.

FIG. 14D is a cross-sectional view of the expansion split sleeve of FIG. 14A in an expanded position.

FIG. 15 is a cross-sectional view of another assembly with an expansion sleeve made from a shape memory alloy, according to one illustrated embodiment.

FIG. 16 is a cross-sectional view of yet another assembly that is radially expandable with an expandable tooling jaw drawn through an expandable split sleeve, according to one illustrated embodiment.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures and methods associated with cold working and/or passing a mandrel through a component to produce some amount of radial expansion of the component may not be shown or described in detail to avoid unnecessarily obscuring descriptions of the embodiments of the invention. It is appreciated and understood that the process of cold working and/or radial expansion may or may not result in the creation of improved fatigue life, which may provide improved characteristics for resisting crack formation, initiation, and/or propagation during operational, thermal, and/or other loading scenarios.

In the following description and for purposes of brevity, reference shall be made to the processes of cold working and/or radial expansion. This reference is not intended to limit or otherwise narrow the scope of the invention. The process of cold expansion is to be broadly interpreted as any process that radially expands at least some of the material of a target component.

Unless the context requires otherwise, throughout the specification and claims which follow the word “comprise” and variations thereof, such as “comprises” and “comprising,” are to be construed in an open, inclusive sense, that is, as “including, but not limited to.”

The headings provided herein are for convenience only and do not interpret the scope or meaning of the claimed invention.

The following description generally relates a method of installing a radially expandable member onto a hollow, elongated member using cold-working/radial-expansion techniques. The radially expandable member may be any type of component that can be received by the elongated member such as a bushing, bearing (e.g., spherical, roller, thrust, etc.), liner, sleeve, gear, sprocket, cam, cam lobe, pawl and ratchet mechanism, coupling, etc. Likewise, the elongated member may be an axle, pin, rod, extension member, shaft, tube, conduit, pipe, spindle, or other similar component. After the assembling process, the radially expandable member and elongated member can be fixedly coupled together. For example, the expandable member in the form of a gear (e.g., a spur gear) can be fixedly coupled to the elongated member in the form of a drive shaft (e.g., a shaft for transmitting significant torques).

In some embodiments, an installation tool is used to draw an expansion mandrel through the elongated member and radially expand at least a portion of the elongated member to create an interference fit with the radially expandable member, which is located on an outer surface of the elongated member. The elongated member may be radially expanded over its entire length. In some embodiments, the elongated member may have one or more features that allow localized radial expansion of one or more portions of the elongated member. An insertable and expandable tool may be inserted into the elongated member and then actuated to radially expand at least a portion of the elongated member to create the interference fit with the radially expandable member. During the radial-expansion process, both the radially expandable member and the elongated member may be at the same, or approximately at the same, temperature. In addition, the radially expandable member is placed onto the elongated member with a clearance fit before any radial expansion of the elongated member has occurred.

The radial expansion process achieves the interference fit between the elongated member and the radially expandable member and may further advantageously achieve a higher contact stress within the interference fit region without requiring the stock elongated member and the stock radially expandable member to have closely-held tolerance ranges. Thus, a wide range of elongated members and radially expandable members with different tolerances, even wide ranges of tolerances, can be conveniently mixed and matched.

The elongated member and the radially expandable member may be assembled together without the need for a large temperature differential between the parts and/or a high axial force to forcibly urge the parts together. Further, post-assembly structural-backup techniques, such as swaging, may not be necessary when the elongated member and the radially expandable member are assembled in accordance with at least one embodiment described herein.

Additional advantages of assembling the elongated member and the radially expandable member using radial-expansion techniques may be achievable. For example, the amount of time required to assemble (e.g., manufacture or produce) the elongated member with the radially expandable member may be reduced. Additionally or alternatively, there may be a reduced likelihood of the outer surface of the elongated member being damaged during assembly. When the outer surface of the elongated member is finished or coated, for example, it may be important to have the capability to keep damage of the outer surface of the elongated member at or below a desired amount.

A multi-piece assembly, including the elongated member and separate radially expandable member, can advantageously replace a traditional one-piece component. One-piece components are often formed of a single material. The multi-piece assembly, however, can be formed of different materials to reduce weight, improve material properties (e.g., strength, toughness, corrosion resistance, ductility), reduce wear, and/or other design criteria. Thus, the multi-piece assembly can be optimized to provide enhanced performance over the traditional one-piece components.

In some embodiments, the elongated member and/or expandable member can be formed of more than one material. For example, the expandable member can be a bi-metallic tubular body. A high wear material can form the surfaces that contact other components, such as a work piece or elongated member. Materials can be selected based on the end use of the elongated member and expandable member.

The elongated member and expandable member can also be formed of the same material. In some embodiments, for example, the elongated member and expandable member are formed the same material so that the elongated member and expandable member have the same or similar coefficient of thermal expansion to minimize, limit, or substantially eliminate thermal stresses.

Yet another possible advantage of the radial-expansion process is that the installer has ample time to diligently and accurately position and/or locate the radially expandable member on the outer surface of the elongated member without having to rush, which is typically necessary during shrink and/or press fit operations.

In some applications, for example, the elongated member is a thrust elongated member used in an engine on an aircraft. The radially expandable member is a radially expandable member located on the thrust elongated member. The radially expandable member includes one or more positioners, such as locking features, for engaging the elongated member. The positioners can facilitate proper placement of the expandable member. Accordingly, the radial expansion process described herein may permit the radially expandable member to be repeatedly and accurately oriented with respect to the thrust elongated member.

These advantages, as well as other, or additional, advantages over conventional assemblies and assembly methods will become apparent and be appreciated by those skilled in the art after reviewing the following detailed description, claims, and figures.

Assembly Components

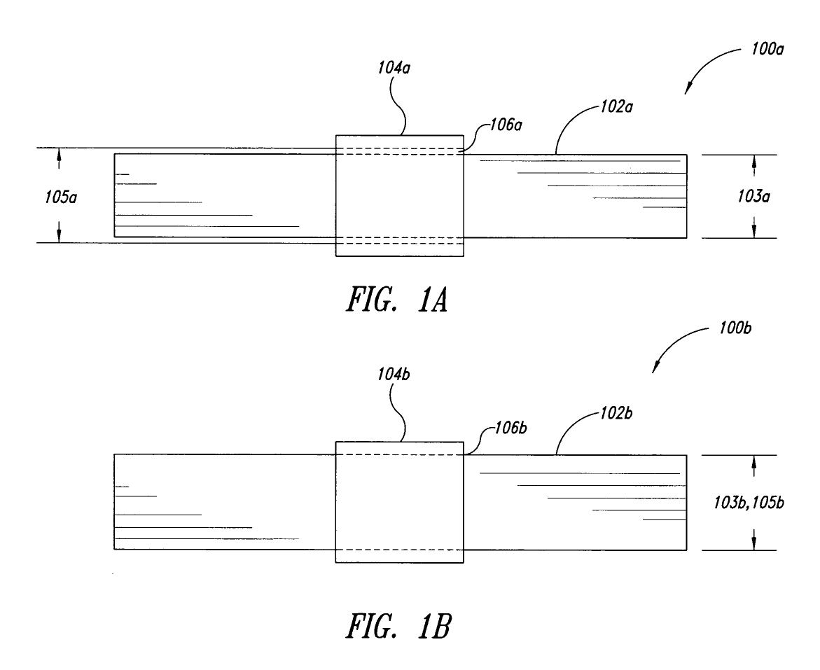

FIG. 1A shows a pre-assembled assembly 100a comprising an elongated member 102a and a radially expandable member 104a in a pre-assembled state. The letter designations “a” and “b” are used to denote the pre-assembled and post-assembled states, respectively, and no letter designation is used to generally refer to the respective components regardless of their state. The pre-assembled radially expandable member 104a is received onto the pre-assembled elongated member 102a. Advantageously, both parts may be at the same, or approximately the same, temperature.

The elongated member 102a and the radially expandable member 104a are dimensioned, with appropriate tolerances, such that the elongated member 102a includes a pre-assembled first outer perimeter 103a and the radially expandable member 104a includes a pre-assembled first inner perimeter 105a. In addition, the radially expandable member 104a may be placed on the elongated member 102a with at least a slight clearance fit 106a. The clearance fit 106a is illustrated as a gap. However, it is appreciated that the clearance fit may include light frictional contact between the radially expandable member 104a and the elongated member 102a. Other types of fits are also possible.

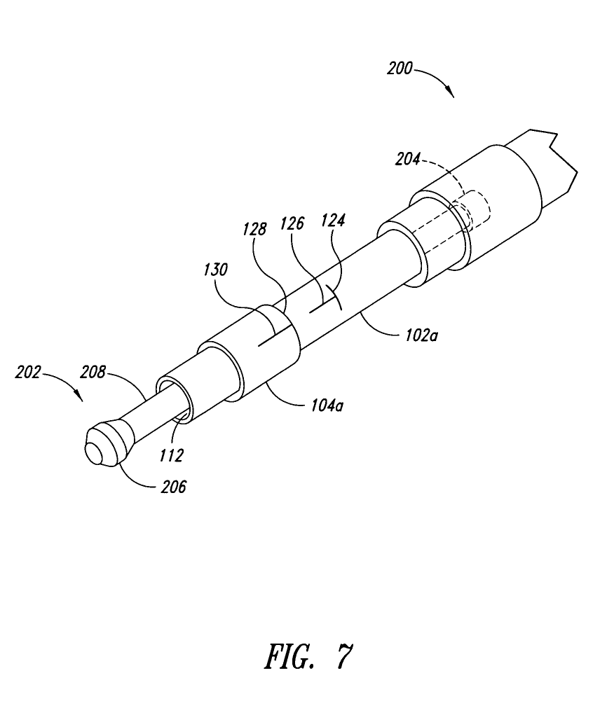

The elongated member 102a and/or the radially expandable member 104a may be indexed to allow for relative circumferential orientation therebetween and/or relative axial orientation therebetween, for example where the radially expandable member 104a is centered or at least approximately centered on the elongated member 102a. At least one form of indexing is described in more detail with reference to FIG. 7. In at least one embodiment, the radially expandable member 104a extends from the elongated member 102a and is fixed thereon via a radial expansion interference fit, as described in greater detail below.

FIG. 1B shows a post-assembled assembly 100b in which the elongated member 102b and the radially expandable member 104b have been radially expanded such that a load path exists for transferring force between the radially expandable member 104b and the elongated component 102b. The radially expanded portion of the elongated member 102b at least partially, axially overlaps with a portion of the post-assembled radially expandable member 104b positioned on the elongated member 102b. In the illustrated embodiment, the entire length of the elongated member 102b has been radially expanded. Thus, the radially-expanded portion of the elongated member 102b located under the radially expandable member 104b forms a tight interference fit 106b with the radially expandable member 104b after radial expansion thereof. Further, the elongated member 102b, after being radially expanded, now includes a post-assembled first outer perimeter 103b, which is greater than the pre-assembled first outer perimeter 103a shown in FIG. 1A. Similarly, the radially expandable member 104b, after being radially expanded, now includes a post-assembled first inner perimeter 105b, which is greater than the pre-assembled first inner perimeter 105a shown in FIG. 1A.

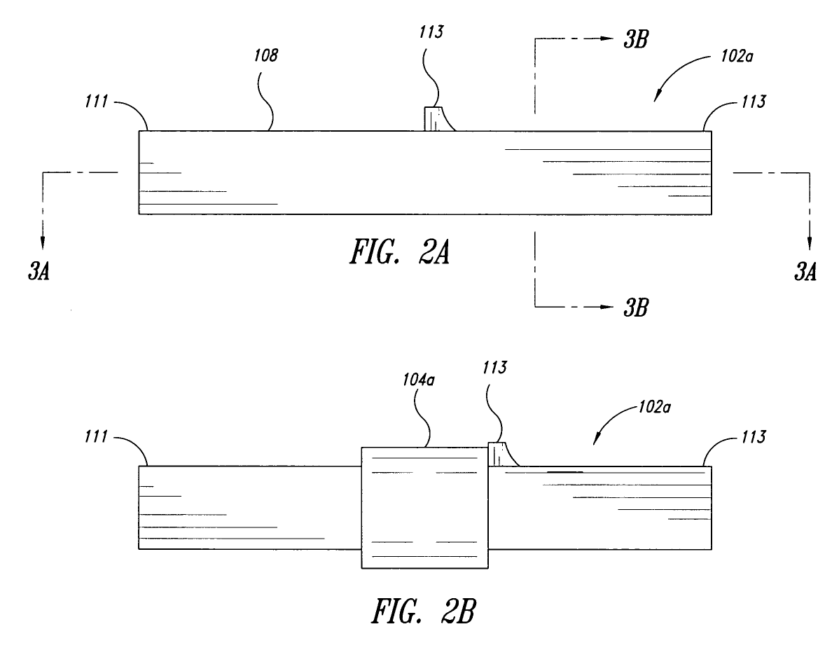

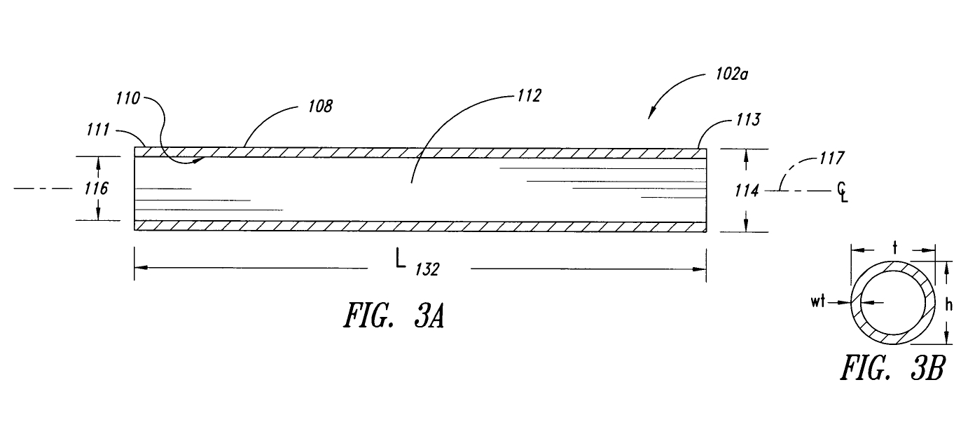

FIGS. 2A, 3A, and 3B show the pre-assembled elongated member 102a in the form of a tubular member, according to one illustrated embodiment. The pre-assembled elongated member 102a includes an outer surface 108 and an inner surface 110 defining a longitudinally extending passage 112 with a centerline or longitudinal axis 117. The outer surface 108 and inner surface 100 extend between a first end 111 and a second end 113, opposing the first end 111. The illustrated elongated member 102a is more slender than the expandable member 104a.

The elongated member 102a can include one or more positioners for positioning an expandable member, such as the expandable member 104a. The illustrated elongated member 102a has a positioner 113 extending outwardly from the outer surface 108. The positioner 113 can inhibit or prevent axial movement of the expandable member relative to the elongated member 102a. The positioner 113 can be a protrusion, flange, spike, shoulder, groove, slot, or other structure suitable for engaging and limiting movement (e.g., angular rotation, axial displacement, etc.) of the expandable member 104a relative to the elongated member 102a.

In some embodiments, the positioner 113 is a locking feature that preferably securely couples the expandable member 104a to the elongated member 102a. Various types of locking structures, such as adhesives, pins, male/female couplers, and the like, can be used to fix (e.g., angularly fix and/or axially fix) the expandable member 104a to the elongated member 102a. The expandable member 104a can thus remain securely fixed to the elongated member 102a before, during, and/or after the expansion process.

The expandable member 104a can optionally have a structure configured to engage the structure 113. For example, the expandable member 104a of FIG. 2B can have a recess or notch configured to receive at least a portion of the positioner 113.

The illustrated elongated member 102a of FIGS. 2A and 2B has a single positioner 113. However, any number of positioners 113 can be used. For example, the expandable member 104a can be disposed between a pair of longitudinally spaced positioners 113 which limit the axial movement of the expandable member along the elongated member 102a.

In other embodiments, the outer surface 108 of FIG. 3A has an outer perimeter 114 that extends uniformly and uninterrupted along a length, L₁₃₂, of the elongated member 102a. The expandable member can slide along the length of elongated member 102a for convenient positioning using, for example, indexing, as described below in connection with FIG. 7. The L₁₃₂ of the elongated member 102a can be greater than the longitudinal length of the expandable member 104a. In some embodiments, the L₁₃₂ of the elongated member 102a is at least 1.5 times the longitudinal length of the expandable member 104a. The first and second ends 111, 113 can protrude outwardly from the expandable member 104a, thereby allowing convenient access to the first and second ends 111, 113. For example, the first and second ends 111, 113 can be mounted into bearings or other components suitable for holding the elongated member 102a. In some embodiments, the length L₁₃₂ is equal to or greater than 2 times, 3 times, 5 times, or 7 times the longitudinal length of the expandable member 104a. Other lengths of the elongated member 102a are also possible.

With reference to FIG. 3A, the inner surface 110 of the elongated member 102a preferably includes an inner perimeter 116 that extends uniformly and uninterrupted along the length, L₁₃₂, of the elongated member 102a. FIG. 3B shows the elongated member 102a having a thickness “t,” a height “h,” and a wall thickness “wt.” Because the illustrated elongated member 102a is a tube with a generally circular profile, the thickness t and height h are approximately equal. In some embodiments, the elongated member 102a is relatively slender. For example, the elongated member 102a can have a slenderness ratio greater than a slenderness ratio of the expandable member 104a. In some embodiments, the slenderness ratio of the elongated member 102a is equal to or greater than 2×, 3×, 10×, or 15× the slenderness ratio of the expandable member 104a.

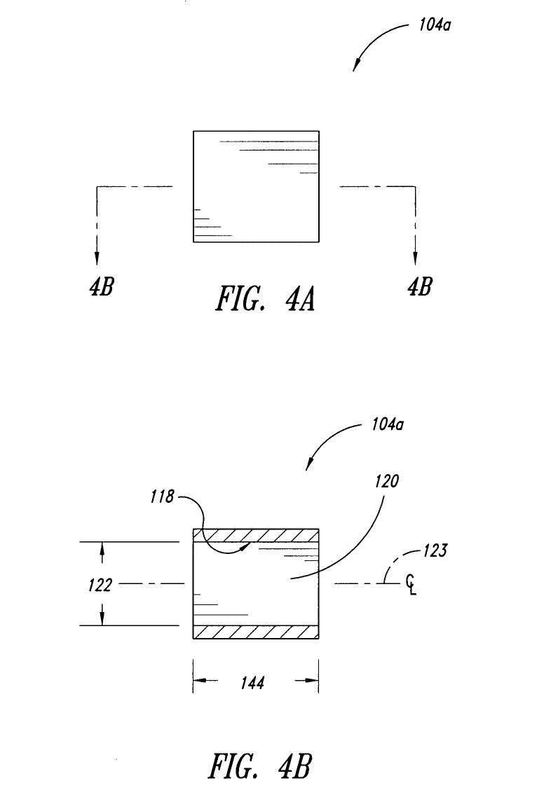

FIGS. 4A and 4B show the pre-assembled radially expandable member 104a, according to one illustrated embodiment. The pre-assembled radially expandable member 104a includes an inner surface 118 surrounding a through-opening 120 with a radially expandable member centerline line or axis 123. In the illustrated embodiment, the inner surface 118 includes an inner perimeter 122 that extends uniformly and uninterrupted along the length, L₁₄₄, of the radially expandable member 104a.

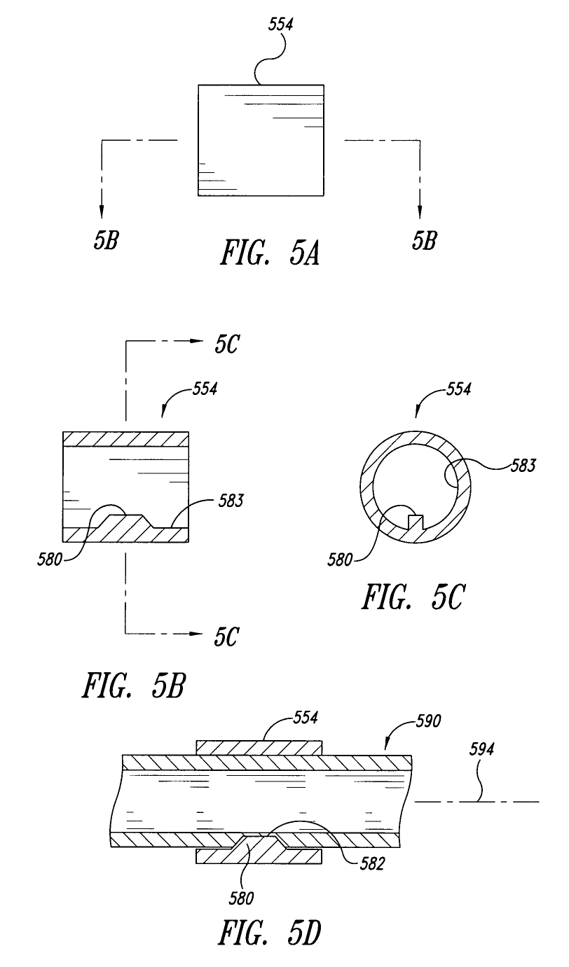

FIGS. 5A to 5C show an expandable member 554 having a positioner 580 for engaging an elongated member. The positioner 580 extends inwardly from an inner surface 583 of the member 554. As shown in FIG. 5D, when the expandable member 554 is assembled with an elongated member 590, the positioner 580 can be received by a corresponding positioner 582 of the elongated member 590. The positioners 580, 582 cooperate to limit, minimize, or substantially prevent relative movement between the expandable member 554 and elongated member 590 before, during, and/or after the cold-working/radial expansion process.

The positioner 582 has a shape that is preferably similar to the shape of the positioner 580. As shown in FIG. 5D, the positioner 580 is a protrusion that extends into the elongated member's positioner 582 (illustrated in the form of a longitudinal recess). In some embodiments, the elongated member's positioner 582 of FIG. 5D is a circumferential groove that limits axial movement of the expandable member 554 while permitting angular rotation of the expandable member 554 about the longitudinal axis 594 of the elongated member 590. Thus, the angular orientation between the expandable member 554 and elongated member 590 can be quickly changed before radial expansion. In yet other embodiments, the positioner 582 is a longitudinally extending slot that permits axial movement of the expandable member 554 relative to the elongated member 590 while limiting angular rotation of the expandable member 554 about the axis 594. The number and positions of the positioners 580, 582 can be selected based on desired movement between the expandable member 554 and elongated member 590.

Tooling

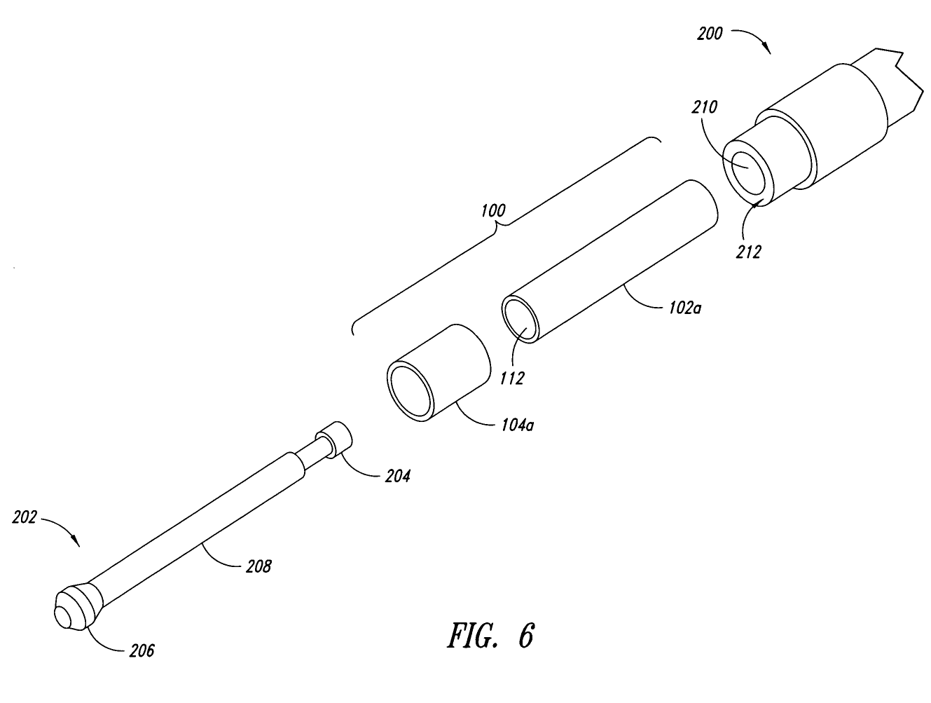

FIG. 6 shows the assembly 100 in a pre-assembled state comprising the elongated member 102a and the radially expandable member 104a. The elongated member 102a and the radially expandable member 104a are coupled together with the assistance of an installation tool 200 and an expansion mandrel 202, according to one illustrated embodiment. The installation tool 200 may be a push or pull-type of a tool. In the illustrated embodiment, the installation tool 200 is of the pull type, operable to pull the expansion mandrel 202 through the opening 112 of the elongated member 102a.

The installation tool 200 includes an engagement receptacle 210 to receive and couple to an engagement portion 204 of the expansion mandrel 202. The installation tool 200 further includes a bearing surface 212 to contact and bear against a portion of the elongated member 102a when the installation tool 200 is operating as a puller tool to draw the expansion mandrel 202 through the opening 112 of the elongated member 102a. The illustrated expansion mandrel 202 includes the engagement portion 204, an expansion head 206, and a mandrel shaft 208 connecting the engagement portion 204 and the expansion head 206.

FIG. 7 shows the engagement portion 204 (shown in phantom) of the expansion mandrel 202 located in the engagement receptacle 210 of the installation tool 200. Both the engagement portion 204 and the mandrel shaft 208 of the expansion mandrel 202 are sized to be passed through the opening 112 of the elongated member 102a without interfering or substantially contacting the inner surface 110 (FIG. 3A) of the elongated member 102a.

The elongated member 102a and/or radially expandable member 104a, in addition, may include one or more indexing marks for both axial and circumferential alignment relative to one another. In some embodiments, the elongated member 102a includes an axial mark 124 and a circumferential mark 126. Likewise, the radially expandable member 104a includes an axial mark 128, which may take the form of an edge of the radially expandable member 104a, and a circumferential mark 130. The marks may be printed, etched, or otherwise inscribed. Before the installation tool 200 is activated to pass the expansion mandrel 202 through the elongated member 102a, the radially expandable member 104a may be aligned relative to the elongated member 102a by using the indexing marks 124, 126, 128, and 130. As noted previously, the radial-expansion process permits an installer to take as much time as is necessary to accurately align and/or orient the radially expandable member 104a relative to the elongated member 102a.

Method(s) for Achieving an Interference Fit

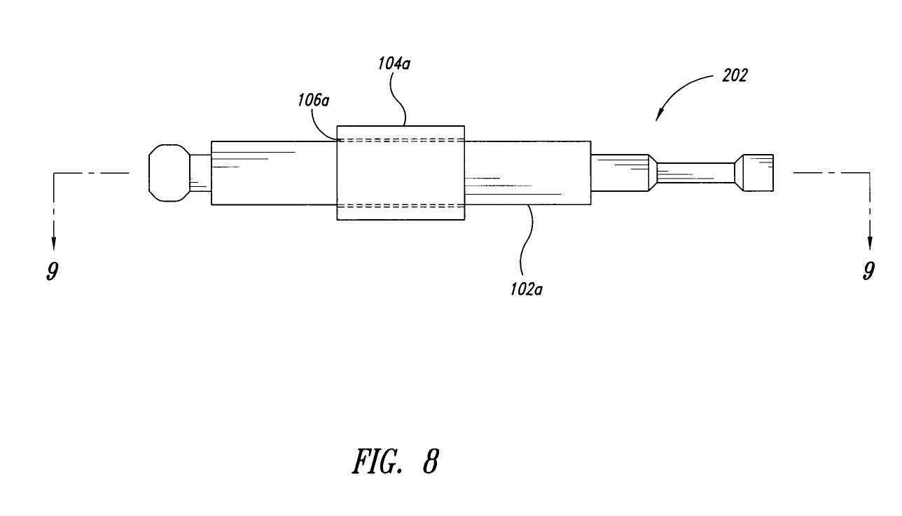

FIG. 8 shows the expansion mandrel 202 located in the elongated member 102a. The radially expandable member 104a has been indexed and aligned on the elongated member 102a. For purposes of clarity, the installation tool 200 (FIG. 7) is not shown in FIGS. 8, 9, and 10.

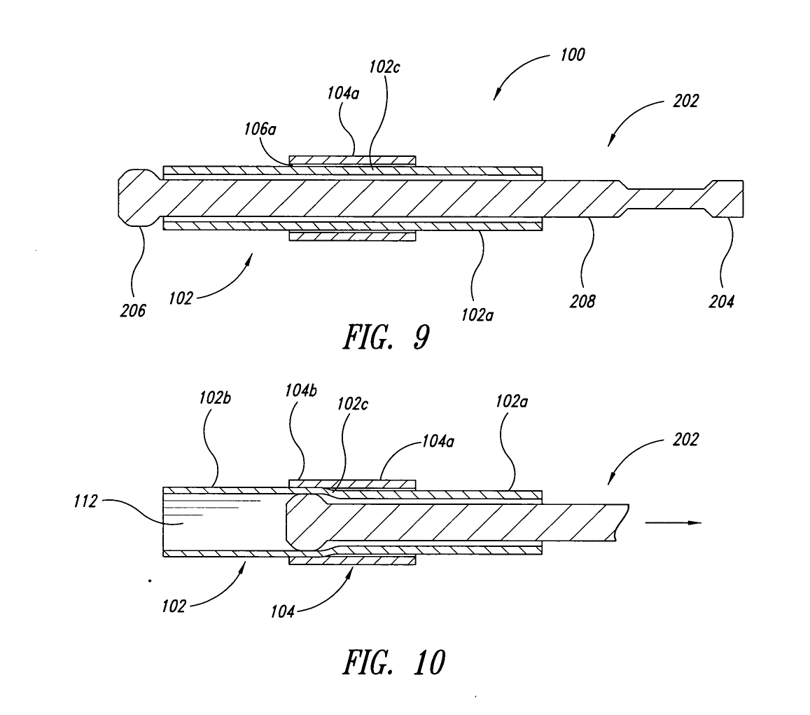

FIGS. 9 and 10 show the expansion head 206 of the expansion mandrel 202 being passed through the opening 112 of the elongated member 102. With the expansion mandrel 202 about halfway through the elongated member 102, the elongated member 102 is shown to have a non-radially expanded portion 102a and a radially-expanded portion 102b (see FIG. 10). The radially expandable member 104 is shown to have a non-radially expanded portion 104a and a radially-expanded portion 104b. As the expansion mandrel 202 passes through the opening 112 of the elongated member 102, the entire length of the elongated member 102 and the entire length of the radially expandable member 104 are radially expanded, according to the illustrated embodiment. The portion 102c of the elongated member 102 overlapped by the radially expandable member 104 achieves a tight interference fit with the radially expandable member 104 as the portion 102c of the elongated member 102 is radially expanded. In this manner, the portion 102c and expandable member 104 are simultaneously expanded.

A desired amount of plastic set and/or deformation can be achieved in the elongated member 102 and/or the expandable member 104. In some embodiments, the elongated member 102 and radially expandable member 104 are radially expanded a sufficient amount to cause at least some plastic deformation in the elongated member 102 and/or expandable member 104. Accordingly, after the expansion mandrel 202 has passed through the elongated member 102 and because of the plastic deformation, the elongated member 102 will achieve and then retain a slightly larger outer perimeter; likewise, the radially expandable member 104 will also achieve and then retain a slightly larger inner perimeter, where the larger perimeters are compared to the pre-assembled configurations of the elongated member 102 and the radially expandable member 104, respectively.

Additional and/or Alternate Embodiments of the Assembly

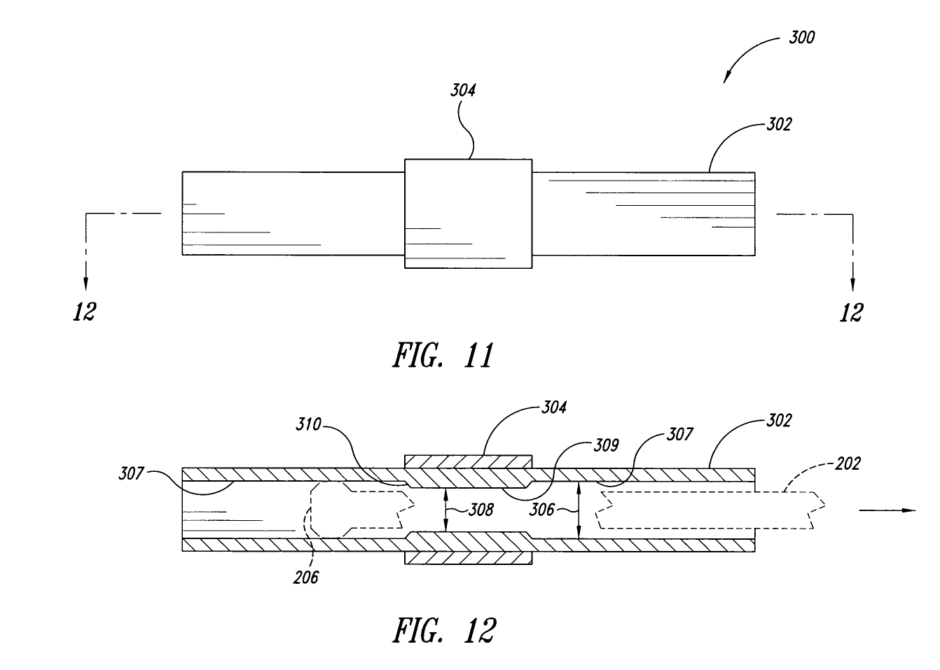

FIGS. 11 and 12 show another assembly 300 comprising an elongated member 302 and a radially expandable member 304. The elongated member 302 includes a first inner perimeter 306 and a second inner perimeter 308. The second inner perimeter 308 is less than the first inner perimeter 306 such that a portion of the elongated member 302 comprises a necked portion section 310 (e.g., a thickened wall section), according to the illustrated embodiment. The expansion mandrel 202, shown in hidden line format, includes an expansion head 206 sized to be passed through the first inner perimeter regions 307 of the elongated member 302 without radially expanding these first inner perimeter regions 307. As the expansion head 206 is passed through a second inner perimeter region 309 of the elongated member 302, the expansion head 206 locally and radially expands the second inner perimeter region 309 of the elongated member 302 to achieve an interference fit with at least a portion of the radially expandable member 304. The length and depth of the thickened wall section 310 may be altered and/or modified to achieve more or less localized radial expansion of the elongated member 302. The illustrated thickened wall section 310 has an axial length that is generally equal to the axial length of the expandable member 304. As such, the entire axial length of the expandable member 304 can be expanded in response to the mandrel 202 expanding the second inner perimeter region 309. In some embodiments, the axial length of the thickened wall section 310 is larger than the axial length of the expandable member 304.

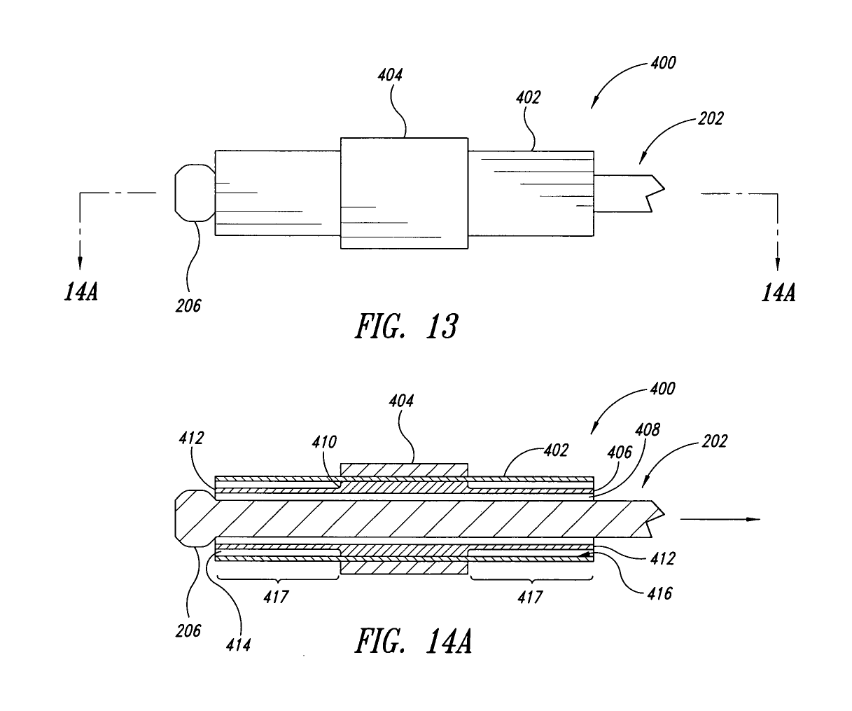

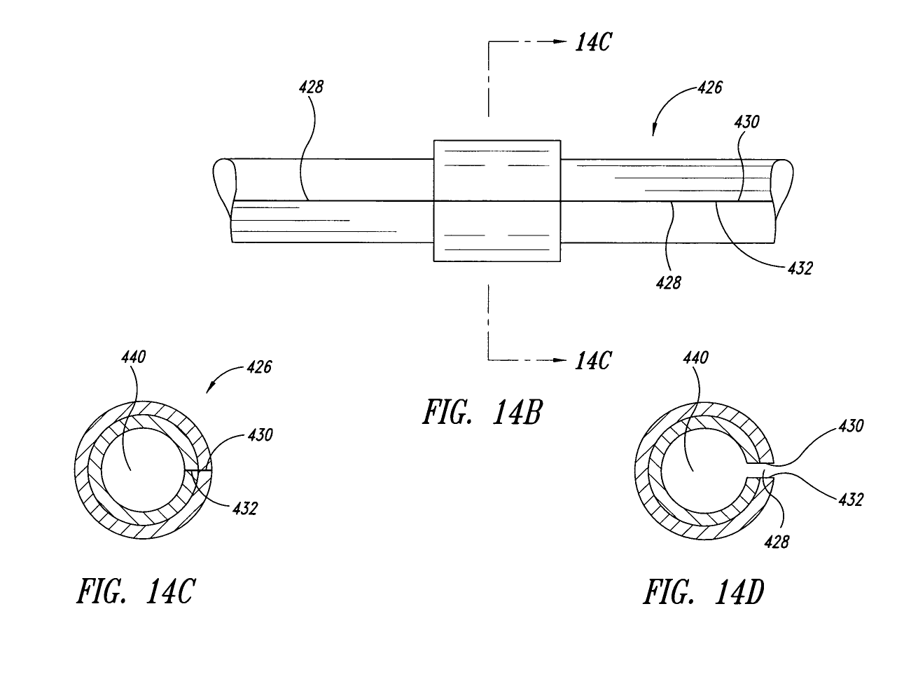

FIGS. 13 and 14A show yet another assembly 400 comprising an elongated member 402 and a radially expandable member 404. As shown in FIG. 14A, the radial expansion of the elongated member 402 is achieved by placing a sleeve 406 having a thickened wall section 410 into an opening 408 of the elongated member 402 and passing the expansion mandrel 202 through the sleeve 406 to radially expand the elongated member 402 and the radially expandable member 404 in a vicinity of the thickened wall section 410. Because the sleeve 406 is between the mandrel 202 and the elongated member 404, the sleeve 406 can prevent or limit frictional forces between the mandrel 202 and the elongated member 402. Thinner walled portions 412 of the sleeve 406 may also be radially expanded, but because of a desired gap or space 414 between the thinner walled portions 412 and an inner surface 416 of the elongated member 402, the radial expansion of the thinner walled portions 412 does not cause any radial expansion of the elongated member 402 along the regions 417 of the elongated member 402.

FIGS. 14B to 14D show another embodiment of a sleeve 426 that is similar to the sleeve 406 of FIGS. 13 and 14A, except as detailed below. The illustrated sleeve 426 is a split sleeve. As used herein, the term “split sleeve” is a broad term that includes, but is not limited to, a sleeve with one or more slits or slots, preferably extending longitudinally along the sleeve. The split sleeve may have least one longitudinal slot formed in the sleeve to allow the perimeter of the sleeve to be expanded and/or contracted (e.g., elastically expanded and/or contracted). In some embodiments, a split sleeve has a plurality of segmented arcuate members (e.g., a pair of longitudinally extending semi-cylindrical sleeve halves). The illustrated split sleeve 426 has a longitudinal slit 428 and is formed by slitting a sleeve (e.g., a cylindrical sleeve) along its entire length. Alternatively, a sheet can be pressed into a somewhat cylindrical configuration such that two edges of the sheet form the longitudinal slit 428.

The illustrated split sleeve 426 is a tubular sleeve having a first edge 430 and a second edge 432 defining the longitudinal slit 428. The first edge 430 and second edge 432 are separate from each other when the split sleeve 426 is radially expanded from its initial position (FIG. 14C) to an expanded position (FIG. 14D).

A mandrel can be used to radially expand the illustrated split sleeve 426. As the mandrel is advanced through a passageway 440, an expanded portion of the mandrel causes the sleeve to separate. The sleeve 426 may split apart along its entire length or a portion thereof. Because the sleeve 426 splits apart, less force may be required to expand the split sleeve 426 as compared to the sleeve 406 of FIG. 14.

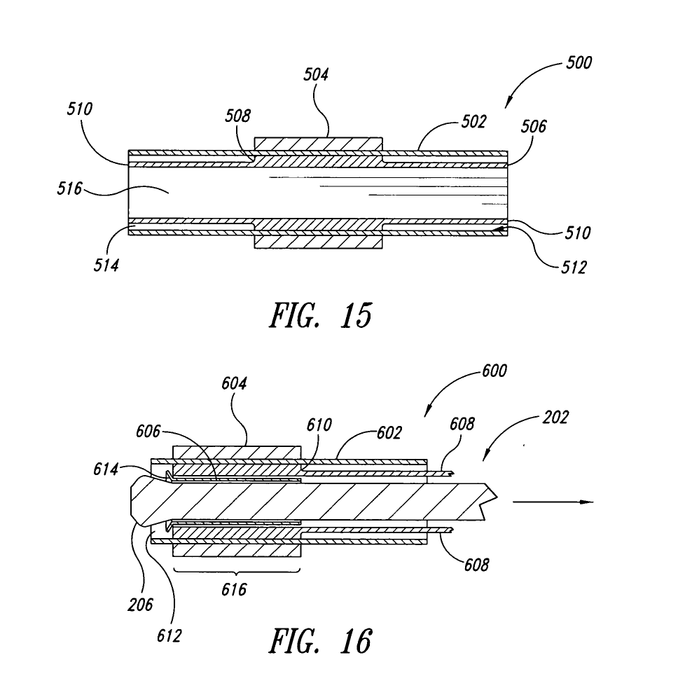

FIG. 15 shows another assembly 500 comprising an elongated member 502 and a radially expandable member 504. Instead of using a mandrel to expand the sleeve and/or the elongated member 502, a sleeve 506 can be self-expanding. As used herein, the term “self-expanding” is to be construed broadly to include, without limitation, expansion that does not require a user to apply an external mechanical force. For example, the illustrated sleeve 506 comprises a self-expanding material (e.g., a shape memory material) that causes radial expansion of the sleeve 506. The shape memory material may include, for example, one or more shape memory alloys (e.g., a nickel titanium alloy), Nitinol, shape memory polymers, combinations thereof, or other materials. The sleeve 506 is preferably configured to transform from a first configuration to a second configuration when it is activated by energy, such as thermal energy, electrical energy, and the like. In some embodiments, the sleeve 506 is heated to radially expand the sleeve 506 from an initial unexpanded configuration to an expanded configuration. As the sleeve 506 self-expands, it radially expands the expandable member 504. Thus, the expandable member 504 can be expanded without using a mandrel or other type of mechanical expansion tool. In some embodiments, a mandrel or other type of mechanical expander can be used in combination with a self-expanding sleeve 506 for a multi-step expansion process.

The sleeve 506 can be configured to achieve localized radial expansion of the elongated member 502. Similar to the sleeve of the previous embodiments, the sleeve 506 includes a thickened walled portion 508 and a thinner walled portion 510. The thickened walled portion 508 is sized to form a slight clearance fit with an inner surface 512 of the elongated member 502. The thinner walled portion 510 is sized so that a gap or space 514 exists between the thinner walled portion 510 of the sleeve 506 and the inner surface 512 of the elongated member 502. The thickened wall portion 508 can comprise a self-expanding material that provides localized radial self-expansion.

The expansion of the elongated members and expandable members described above can be achieved in a variety of ways. Means of expansion include, without limitation, applying mechanical loads (e.g., expansion via a mandrel), temperature loads (e.g., heating a sleeve itself) running an electrical current through a sleeve, and/or applying a load or force by other suitable means. For example, a hydrostatic pressure can be applied to an interior surface of a sleeve or elongated member. In some embodiments, a pressurized fluid fills the interior region 516 of the sleeve 506. The fluid pressure can be increase until the desired level of expansion is achieved. The working pressure of the fluid can be selected based on the strength (e.g., the yield strength) of the sleeve 506. A thin walled section of the sleeve 506 can be adjacent to the expandable member 504. When the pressurized fluid fills the sleeve 506, the thin walled section of the sleeve 506 deforms causing corresponding deformation of the expandable member.

FIG. 16 shows yet another assembly 600 comprising an elongated member 602 and a radially expandable member 604. In the illustrated embodiment, the radial expansion of the assembly 600 is achieved when the expansion mandrel 202 is passed through a split sleeve 606 and a tooling jaw 608. As discussed above, a split sleeve is generally understood to have at least one longitudinal slot formed in the sleeve to allow the perimeter of the sleeve to be elastically expanded and/or contracted. By way of example, the split sleeves described in U.S. Pat. Nos. 3,566,662 and 3,665,744 could be used. The tooling jaw 608 is coupled to the installation tool 200 (FIG. 7) and includes an expansion portion 610. The location of the tooling jaw 608 with respect to the installation tool may be adjusted so the tooling jaw 608 extends a desired distance into an opening 612 of the elongated member 602. The tooling jaw 608 may include one or more longitudinal and/or axial slots that allow the jaw 608 to expand and contract for easy insertion and removal relative to the elongated member 602, according to one embodiment.

The split sleeve 606 may be placed on the expansion mandrel 202 before the mandrel 202 is inserted through the opening 612 in the elongated member 602 and/or tooling jaw 608. The split sleeve 606 includes a flared end portion 614 that keeps the split sleeve 606 from being passed through the opening 612 in the tooling jaw 608. In the illustrated embodiment, the expansion mandrel 202 is shown being pulled through the opening 612. After a localized portion 616 of the assembly 600 has been radially expanded to establish an interference fit between the elongated member 602 and the radially expandable member 604, the split sleeve 606 and the tooling jaw 608 are removed from the opening 612 of the elongated member 602.

The various embodiments described above can be combined to provide further embodiments. All of the above U.S. patents, patent applications and publications referred to in this specification, as well as U.S. Pat. Nos. 3,566,662; 3,892,121; 4,187,708; 4,423,619; 4,425,780; 4,471,643; 4,524,600; 4,557,033; 4,809,420; 4,885,829; 4,934,170; 5,083,363; 5,096,349; 5,405,228; 5,245,743; 5,103,548; 5,127,254; 5,305,627; 5,341,559; 5,380,136; 5,433,100; and in U.S. patent application Ser. Nos. 09/603,857; 10/726,809; 10/619,226; and 10/633,294 are incorporated herein by reference. Aspects can be modified, if necessary, to employ devices, features, and concepts of the various patents, applications, and publications to provide yet further embodiments.

These and other changes can be made in light of the above-detailed description. In general, in the following claims, the terms used should not be construed to limit the invention to the specific embodiments disclosed in the specification and the claims, but should be construed to include all types of elongated members assembled with another component that is located on an outer surface of the elongated member, where an interference fit is achievable therebetween, and that operate in accordance with the claims. Accordingly, the invention is not limited by the disclosure, but instead its scope is to be determined entirely by the following claims.

What is claimed is:

1. A load path assembly, comprising:
an elongated shaft having a first end, a second end, an outer surface, and an inner surface, the outer surface and inner surface extending between the first end and the second end, the inner surface forming a longitudinally extending passage; and
a radially extending member having an outer surface and an inner surface forming an axial passage, wherein the elongated shaft is longitudinally received in the axial passage of the radially extending member such that the radially extending member radially extends from the elongated shaft and is fixed thereon via a radial expansion interference fit between at least a portion of the outer surface of the elongated shaft and at least a portion of the inner surface of the radially extending member.

2. The load path assembly of claim 1 wherein the elongated shaft is a slender tube having an axial length that is at least twice as long an axial length of the radially extending member.

3. The load path assembly of claim 1 wherein an axis of the axial passage is substantially parallel to a longitudinal axis of the longitudinally extending passage.

4. The load path assembly of claim 1 wherein the inner surface of the elongated shaft includes an inner perimeter that is uniform over a length of the longitudinally extending passage of the elongated shaft.

5. The load path assembly of claim 1 wherein a portion of the longitudinally extending passage of the elongated shaft includes a necked portion having an inner perimeter that is less than an inner perimeter of another portion of the longitudinally extending passage of the elongated shaft.

6. The load path assembly of claim 5 wherein the necked portion of the longitudinally extending passage of the elongated shaft is radially aligned with the portion of the outer surface of the elongated shaft that forms the radial expansion interference fit with the radially extending member.

7. The load path assembly of claim 1 wherein the outer surface of the elongated shaft includes an indexing feature thereon to locate the radially extending member.

8. The load path assembly of claim 1 wherein the radial expansion interference fit is formed with the elongated shaft and the radially extending member each at approximately a same temperature.

9. The load path assembly of claim 1, further comprising:
a sleeve positioned in the longitudinally extending passage of the elongated shaft, the sleeve having a thickened wall portion radially adjacent the radially extending member.

10. The load path assembly of claim 1 wherein the radially extending member is selected from the group consisting of a radially expandable member, a liner, a gear, a sprocket, and a cam.

11. The load path assembly of claim 1 wherein the elongated shaft is selected from the group consisting of an axle, a rod, an extension member, and a splined shaft.

12. An assembly, comprising:
a member having an outer surface and an inner surface forming an axially extending passage; and
an elongated shaft having an outer surface and an inner surface forming a longitudinally extending passage, the longitudinally extending passage of the elongated shaft having a pre-assembled radial dimension that provides a clearance fit with the inner surface of the member and a post-assembled radial dimension that provides a radially expanded interference fit between at least a portion of the outer surface of the elongated shaft and at least a portion of the inner surface of the member, the elongated shaft has longitudinal length that is relatively large as compared to a longitudinal length of the member.

13. The assembly of claim 12 wherein an axis of the axially extending passage of the member is parallel to a longitudinal axis of the longitudinally extending passage of the elongated shaft.

14. The assembly of claim 12 wherein the inner surface of the elongated shaft includes an inner perimeter that is uniform over a length of the longitudinally extending passage.

15. The assembly of claim 12 wherein a portion of the longitudinally extending passage of the elongated shaft includes a necked portion having an inner perimeter that is less than an inner perimeter of another portion of the longitudinally extending passage of the elongated shaft.

16. The assembly of claim 15 wherein the necked portion of the longitudinally extending passage of the elongated shaft is radially aligned with the portion of the outer surface of the elongated shaft that forms the radial expansion interference fit with the member.

17. The assembly of claim 12 wherein the outer surface of the elongated shaft has a pre-assembled outer perimeter dimension that is less than a post-assembled radially expanded outer perimeter dimension.

18. The assembly of claim 12 wherein a pre-assembled inner perimeter dimension of the inner surface of the member is less than a post-assembled radially expanded inner perimeter dimension of the inner surface of the member.

19. The assembly of claim 12 wherein the outer surface of the elongated shaft includes an indexing feature thereon to locate the member.

20. The assembly of claim 12 wherein the radial expansion interference fit is formed with the elongated shaft and the member each at approximately a same temperature.

21. The assembly of claim 12 wherein at least a portion of the member is rotatable about the longitudinal shaft after forming the interference fit.

22. A method of forming an assembly from an elongated shaft having an outer surface and an inner surface forming a longitudinal passage, and from a member having an outer surface and an inner surface forming an axial passage, the method comprising:
positioning at least a portion of the elongated shaft in at least a portion of the axial passage of the member such that the member radially extends from the elongated shaft;
passing at least a portion of a mandrel through the longitudinal passage of the elongated shaft; and
radially expanding at least a portion of the elongated member to form a radial expansion interference fit between at least a portion of the outer surface of the elongated shaft and at least a portion of member.

23. The method of claim 22 wherein the elongated shaft and the member are at approximately a same temperature when the elongated shaft is positioned in the radial passage of the member.

24. The method of claim 22 wherein the elongated shaft and the member are at approximately a same temperature when radially expanding the elongated shaft to form the radial expansion interference fit.

25. The method of claim 22 wherein an axis of the axial passage is approximately parallel to a longitudinal axis of the longitudinal passage.

26. The method of claim 22, further comprising:
radially aligning the member about the elongated shaft using at least one index feature before the radially expanding, the at least one index feature positioned along at least one of the elongated shaft and the member.

27. The method of claim 22, further comprising:
longitudinally aligning the member along the elongated shaft using at least one index feature before the radially expanding, the at least one index feature positioned along at least one of the elongated shaft and the member.

28. The method of claim 22 wherein the longitudinal passage has an approximately uniform diameter over a length of the longitudinal passage and wherein radially expanding at least a portion of the elongated member to form a radial expansion interference fit between at least a portion of the outer surface of the elongated shaft and at least a portion of member comprises successively physically deformingly engaging a portion of the longitudinal passage with an expanded perimeter portion of the mandrel.

29. The method of claim 22 wherein the longitudinal passage of the elongated shaft has a necked portion and wherein radially expanding at least a portion of the elongated member to form a radial expansion interference fit between at least a portion of the outer surface of the elongated shaft and at least a portion of member comprises successively physically deformingly engaging the necked portion of the longitudinal passage with a portion of the mandrel.

30. The method of claim 22, further comprising:
positioning a sleeve having a non-uniform wall thickness in at least a portion of the longitudinal passage of the elongated shaft before the radially expanding, and wherein radially expanding at least a portion of the elongated member to form a radial expansion interference fit between at least a portion of the outer surface of the elongated shaft and at least a portion of member comprises successively physically deformingly engaging the sleeve positioned in the longitudinal passage with a portion of the mandrel.

31. The method of claim 22, further comprising:
selecting the member from the group consisting of a radially expandable member, a liner, a gear, a sprocket, and a cam; and
selecting the elongated shaft from the group consisting of an elongated member, an axle, a rod, an extension member, a splined shaft.
